(19) United States
(12) Patent Application Publication
(10) Pub. No.: US 2007/0058925 A1
(43) Pub. Date: Mar. 15, 2007

(54) Interactive multimedia production

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,084

(22) Filed: Sep. 14, 2005

(51) Int. Cl. H04N 5/93

(52) U.S. Cl. 386/52

(57) ABSTRACT

Interactive multimedia production with polling, quizzing, and chatroom features for an interactively-connected audience. The production allows a producer to select and queue individual feeds from audience members for inclusion in the media output. Live text-based support allows audience members to contact a user support staff member for assistance. The production optionally allows advertising to be targeted to audience members via user profiles. Audio-video feed from selected audience members is integrated into studio audio-video signal and broadcast via satellite TV, cable TV, or the internet.

### BACKGROUND OF THE INVENTION

1. Field of the Invention

The present invention relates to media production. More specifically, the present invention discloses interactive multimedia production able to transmit and receive audio-visual feeds with audience members over the internet or other network, producing an edited output and an unedited output, and featuring a moderated chat room with polling.

2. Description of the Prior Art

Traditionally, media production for television has been done in the limiting environment of a studio. A few cast members and a production crew would create the content on a set with a small number of cameras, optionally with a studio audience present. Editing was performed in a control room, with a director, a producer, an editor, and a sound engineer vying to create an edited output for live or recorded broadcast. Audiences had to come to the studio in order to see the show being produced and, optionally, to participate in the show.

However, the production facility and trained crews were extremely expensive, limiting the ability to produce television media content. Some show formats required the participation of a studio audience, which required facilities to hold the audience and personnel to deal with the problems a live audience could cause. In addition, audiences were limited to the population of people who could make it to the studio at a given time, and to the number of people who could be fit into the studio.

Therefore there is need for an interactive multimedia production that reduces the overhead necessary for providing a studio audience and expands the ability of viewers to participate in the media production.

### SUMMARY OF THE INVENTION

To achieve these and other advantages and in order to overcome the disadvantages of the conventional method in accordance with the purpose of the invention as embodied and broadly described herein, the present invention provides interactive multimedia production that accepts audio-video and audio feeds over an internet for audience participation, and that has software to manage the internet audience feeds.

The present invention further provides facilities for audience participation via polling, interactive text chatting among the audience, and online assistance for individual audience members.

The present invention further provides interactive multimedia production that outputs both an edited media production and an unedited media production.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing an interactive multimedia production system according to an embodiment of the present invention;

FIG. 2 is a block diagram illustrating a control panel of an embodiment of the present invention;

FIG. 3 is a block diagram of a client software display panel of an embodiment of the present invention;

FIG. 4 is a block diagram showing a control room according to an embodiment of the present invention;

FIG. 5A-5B are flowcharts illustrating interactive multimedia production according to an embodiment of the present invention; and

FIG. 6A-6B are flowcharts illustrating interactive multimedia production according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

In order to better understand the interactive multimedia production of the present invention, a detailed discussion of the system utilizing the present invention is given.

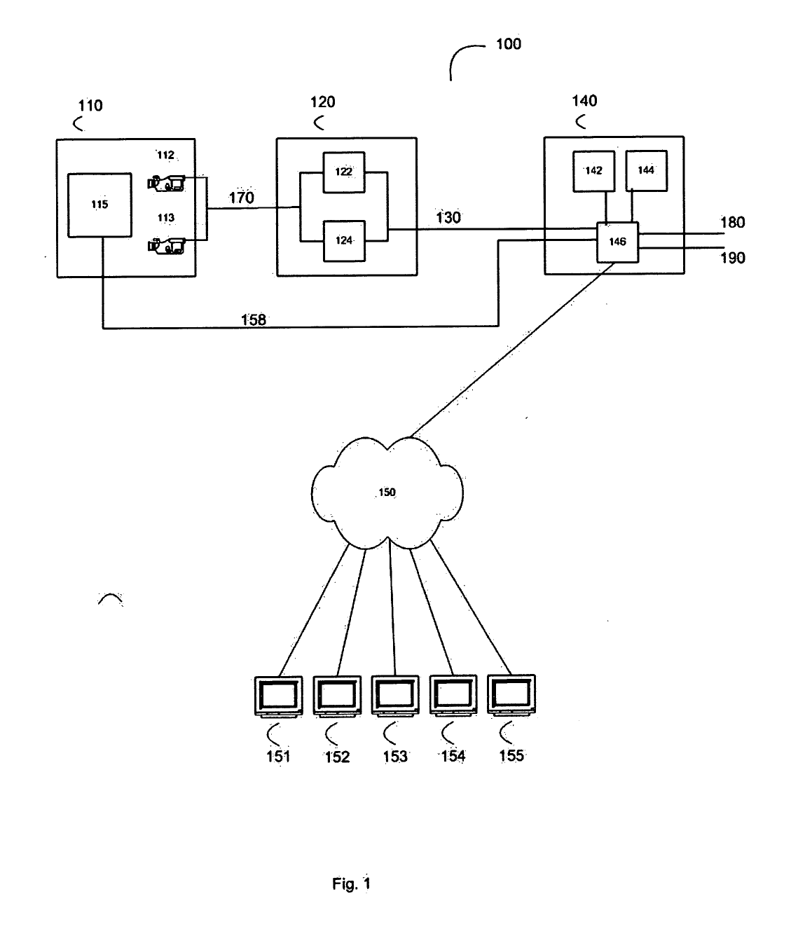

Please refer to FIG. 1, which shows an interactive multimedia production system according to an embodiment of the present invention. The system 100 has a studio 110 in which the show is created using video cameras 112˜113. The studio also has a host display 115 on which various information can be displayed, such as teleprompter text (not shown) or a selected audience feed 158 discussed below. The studio outputs a studio feed 170 to a primary control room 120 in which the show is edited. The primary control room 120 has an audio control panel 122 and a video editing control panel 124. The primary control room 120 outputs an audio-video feed 130 to the secondary control room 140.

The secondary control room 140 has a content control panel 146, which takes internet 150 audio-video or audio-only audience feeds 151˜155 as inputs, and at which an operator can choose and queue a selected audience feed 158. It should be noted that while five audience feeds 151˜155 are shown, this is for exemplary purposes only, and the number of feeds is neither fixed nor limited. The selected audience feed 158 is controlled with audio control panel 142 and video editing control panel 144, sent to the host display 115 so that the host can interact with the audience member who is sending the selected audience feed 158, and mixed into an unedited output 180. The secondary control room 140 also produces an edited output 190 from the unedited output 180, either or both of which can be broadcast, webcast, and/or saved for later use.

In typical operation of one embodiment, the edited output 190 is saved for broadcast, while the internet audience can view the unedited output 180 in real-time as it is created. Internet audience members can connect and disconnect at their convenience, joining late or leaving early according to their own schedules and interests.

It should be noted that the primary control room 120 and secondary control room 140 can be located in the same room or building or situated remotely from each other.

Additionally, while only one audience feed 158 is shown in the figure, any number of audience feeds can be used for interaction.

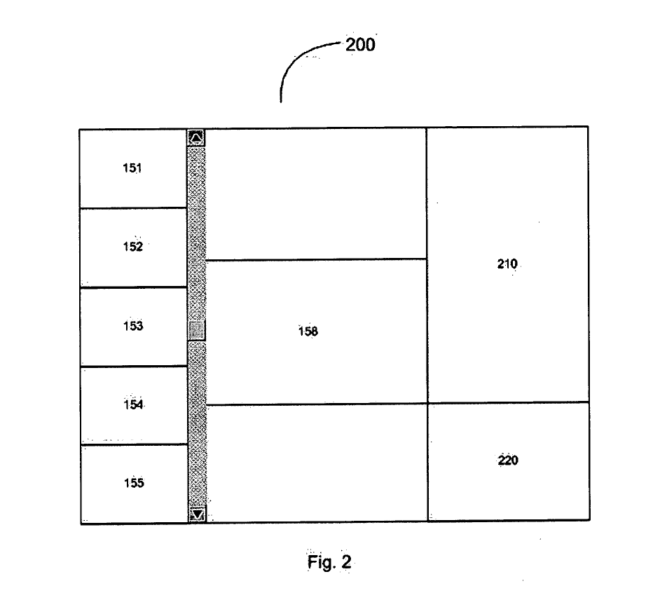

Please refer to FIG. 2, which shows a block diagram of a software content control panel 200 of an embodiment of the present invention. The content control panel 200 allows a content controller or content controllers to view and listen to the audience feeds 151˜155 of all currently connected remote audience members, scrolling through the list if too many are connected to fit on one screen, and to select an audience feed for broadcast as the selected audience feed 158. The content control panel 200 also allows the content controller to view and participate in discussion in the chat room 210 and to create polls and quizzes in a sub panel 220. Results from the polls and quizzes are displayed in the sub panel 220 and can be used by the content controller in the selection of the selected audience feed 158.

The figure shows all audience feeds 151-155 displayed. Alternatively, only the active audience feed or feeds can be displayed when selected by the content controller. Limiting the number of displayed feeds saves bandwidth.

In operation, the content controller selects an audience feed of the audience feeds 151˜155 to be the selected audience feed 158, checks that the audio and video of the selected audience feed 158 are functioning, and queues the selected audience feed 158 for use in the show. The audio signal of the selected audience feed 158 is passed to an audio engineer for setting the sound level on the audio control panel 142, and the video signal of the selected audience feed 158 is passed to a video engineer to be added into the unedited output 180. In a game-show format, for example, the content controller may create a quiz or poll which is sent to the remote audience, and the fastest audience member to answer the quiz or poll may then be the one selected by the content controller for queuing to be the selected audience feed 158. The content controller can communicate with the audience member to ensure that the audience member is able to receive an audio-video feed from the show and send an audio-video feed to the show.

Further, a chat room monitor can monitor the chat room 210, either approving each piece of discussion text as an audience member submits it or allowing open discussion. The chat room monitor can block audience members who are misbehaving or being disruptive.

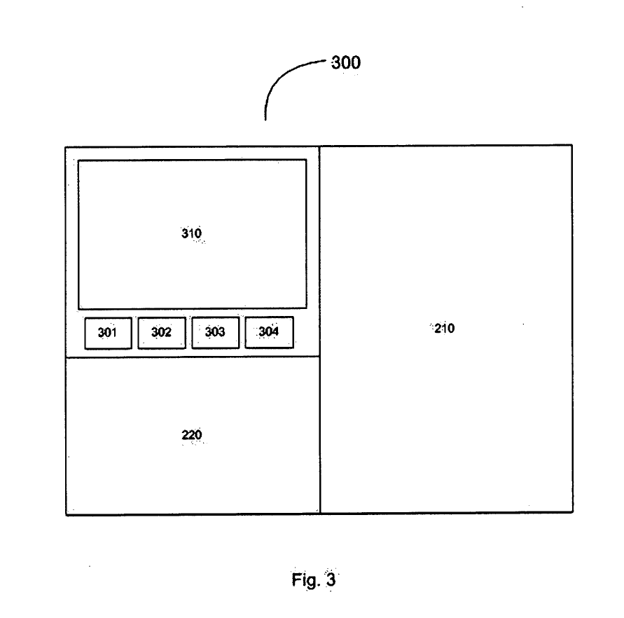

Please refer to FIG. 3, which shows a diagram of a client software display panel 300 of an embodiment of the present invention. This view is an example of what a remote audience member may see on his or her computer. The user panel 300 displays the chat room 210, and a quiz or poll area 220, and either the edited output feed 190 or the unedited output feed 180 in a display area 310. Advertising may be displayed in any or all of these areas from time to time under the control of the system, and may be narrowly targeted to the user based on group or even individual profiles. The user may also display his or her user feed or other user's feeds in the display area 310, for example by clicking one of the user feed panes 301˜304. At user request, a text-based live help panel is displayed (not shown), through which the user may request assistance from the producer's user support personnel. The user can type into the chat room 210 to broadcast discussion items to all other audience members. The user can also participate in any polls or quizzes that are sent by the show producers via the quiz or poll area 220.

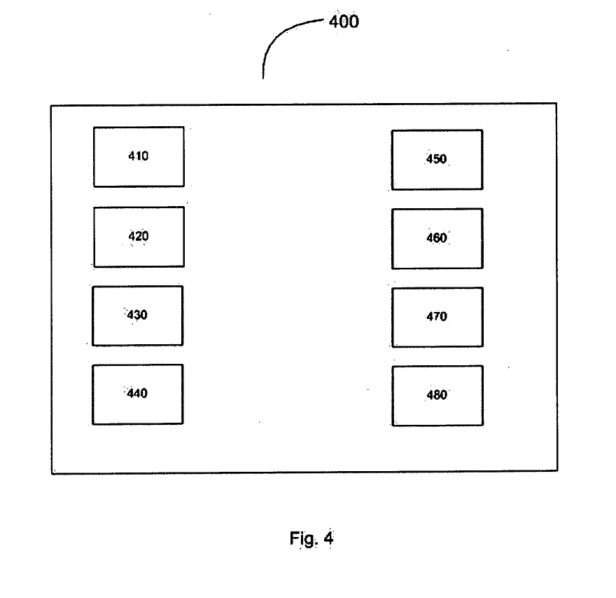

Please refer to FIG. 4, which shows a block diagram of a control room of an embodiment of the present invention. The control room 400 contains stations for a content controller 410, an audience sound engineer 420, a user support monitor 430, and a chat room monitor 440. The control room may optionally have stations for a director 450, a producer 460, an editor 470, and a primary sound engineer 480.

This interactive multimedia production thus provides a dramatic improvement over the prior art, allowing a wide audience to participate in interactive television shows.

Additionally, with the interactive multimedia production of the present invention, audio-video feeds from selected audience members are integrated with the studio audio-video signal and broadcast via satellite TV, cable TV, or the internet. Users can view the full interactive content on a TV connected to a set top box or on computers connected to the internet. Viewers using traditional televisions may be able to see the total multi-paned interface including the chartroom and other panes or may be limited to only seeing the integrated studio and audience media signal and not see the chatroom and other panes.

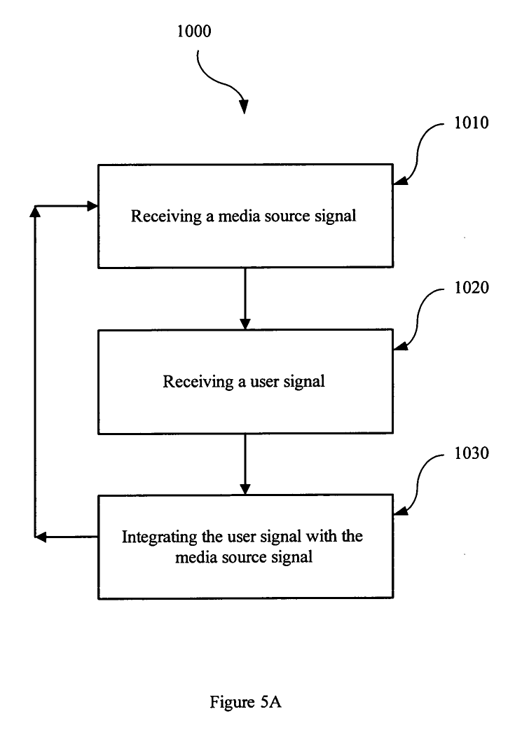

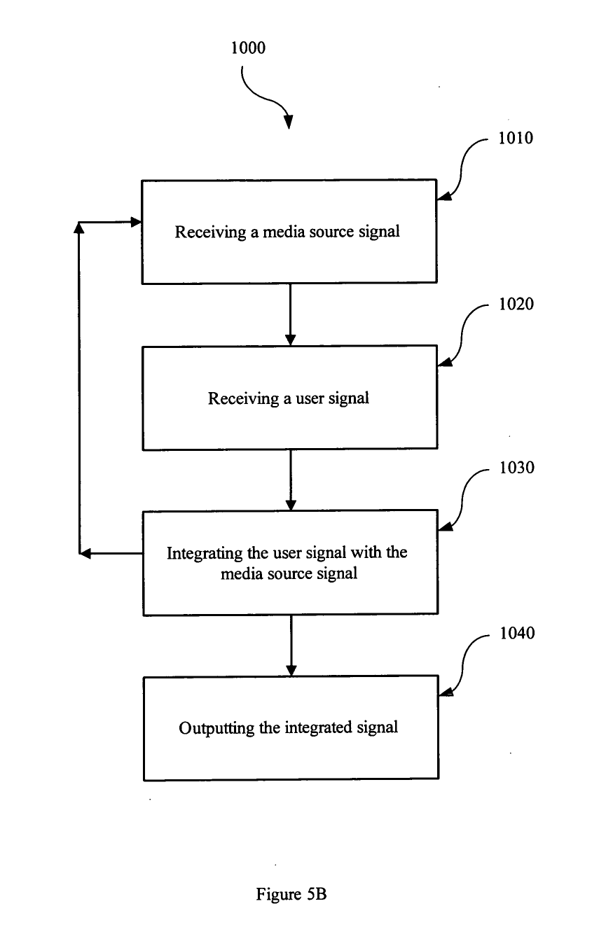

Refer to FIG. 5A, which is a flowchart illustrating interactive multimedia production according to an embodiment of the present invention.

As shown in FIG. 5A, the interactive multimedia production 1000 begins by receiving a media source signal in step 1010. Then in step 1020, a user signal is received. The user signal is then integrated with the media source signal in step 1030. The production returns to step 1010 and continues to cycle through steps 1010, 1020, and 1030. In this embodiment the user signal and the media source signal are media streams or multimedia signals that are continuously combined into an integrated media signal.

For example, if the media source signal is a television broadcast and the user signal is a audio and video stream from a web camera, the user's video and audio is combined with the television signal to create an integrated signal displaying the user's video and the television signal in a single display.

Refer to FIG. 5B, which is a flowchart illustrating interactive multimedia production according to an embodiment of the present invention.

The embodiment illustrated in FIG. 5B is similar to FIG. 5A but with the addition of outputting the integrated signal in step 1040. In this embodiment the media source signal and user's signal are continuously integrated and output. For example, the integrated signal could be sent across the internet for viewing or broadcast via television.

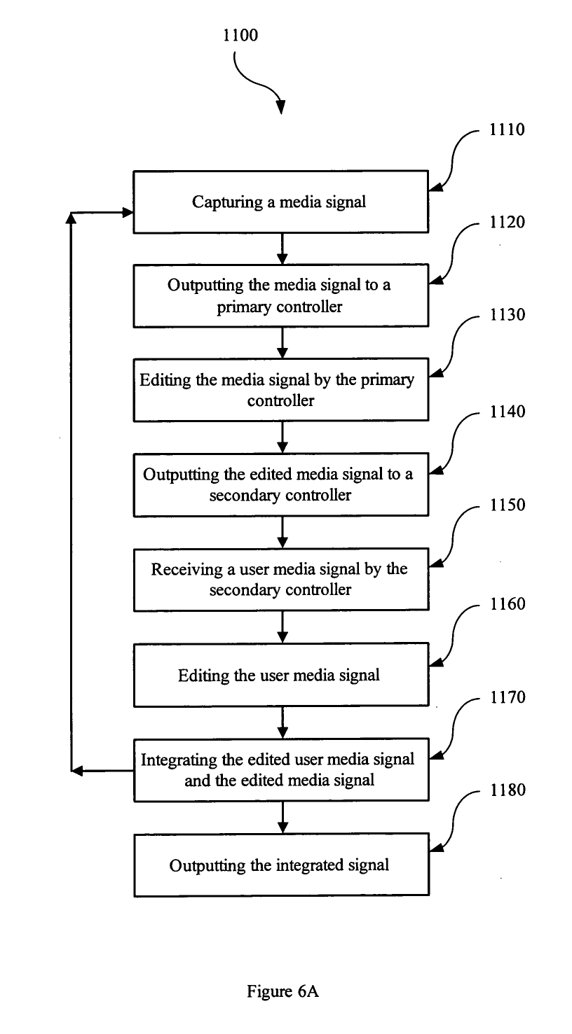

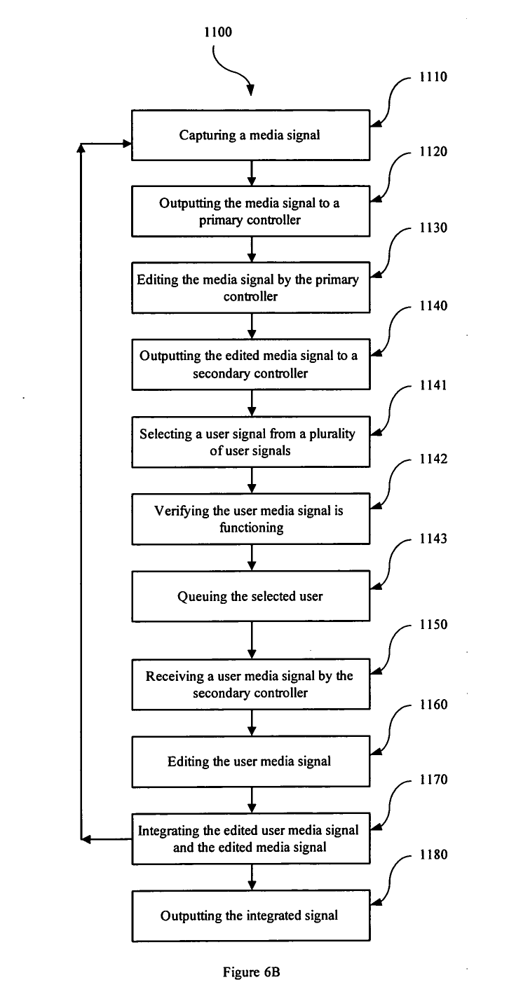

Refer to FIG. 6A, which is a flowchart illustrating interactive multimedia production according to an embodiment of the present invention.

As shown in FIG. 6A, the interactive multimedia production 1100 begins by capturing a media signal in step 1110. In step 1120, the media signal is output to a primary controller and in step 1130, the primary controller edits the media signal and outputs the edited media signal to a secondary controller in step 1040. In step 1150, the secondary controller begins receiving a user media signal and edits the user media signal in step 1160. In step 1170, the edited user media signal and the edited media signal are integrated and the integrated signal is output to users, controllers, and artists captured in the media signal so that they can interact in step 1180.

It should be noted that the entire cycle is continuously repeated in order to produce a continuous integrated multimedia signal.

Refer to FIG. 6B, which is a flowchart illustrating interactive multimedia production according to an embodiment of the present invention.

The embodiment shown in FIG. 6B is similar to FIG. 6A but with additional steps: step 1141, in which a user media signal is selected from a plurality of user media signals; step 1142, in which the user media signal is verified to be functioning; and step 1143, in which the selected user is queued.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of producing multimedia, comprising:
receiving a media source signal;
receiving a user signal; and
integrating the user signal with the media source signal to form an integrated signal.

2. The method of producing multimedia of claim 1, further comprising outputting the integrated signal.

3. The method of producing multimedia of claim 2, wherein the integrated signal is output to a user producing the user signal and to users producing the media source signal so that they may interact with each other.

4. The method of producing multimedia of claim 1, wherein the user signal is selected from a plurality of user signals.

5. The method of producing multimedia of claim 1, further comprising capturing the media signal.

6. The method of producing multimedia of claim 1, further comprising editing the media source signal and the user signal.

7. The method of producing multimedia of claim 6, wherein the media source signal is edited by a primary controller.

8. The method of producing multimedia of claim 6, wherein the user signal is edited by a secondary controller.

9. The method of producing multimedia of claim 1, further comprising verifying the user media signal is functioning.

10. The method of producing multimedia of claim 4, further comprising queuing the selected user signal.

11. A method of producing interactive multimedia, comprising:
capturing a media signal;
outputting the media signal to a primary controller;
editing the media signal by the primary controller;
outputting the edited media signal to a secondary controller;
receiving a user media signal by the secondary controller;
editing the user media signal by the secondary controller; and
integrating the edited user media signal and the edited media signal to create an integrated signal.

12. The method of producing interactive multimedia of claim 11, further comprising outputting the integrated signal.

13. The method of producing interactive multimedia of claim 12, wherein the integrated signal is output to a user producing the user signal and to users producing the media signal so that they may interact with each other.

14. The method of producing interactive multimedia of claim 11, wherein the user media signal is selected from a plurality of user media signals.

15. The method of producing interactive multimedia of claim 11, further comprising selecting the user media signal from a plurality of user media signals.

16. The method of producing interactive multimedia of claim 11, further comprising verifying the user media signal is functioning.

17. The method of producing interactive multimedia of claim 15, further comprising queuing the selected user media signal.

18. A method of producing interactive multimedia, comprising:
capturing a media source signal;
outputting the media source signal to a primary controller;
editing the media source signal by the primary controller;
outputting the edited media source signal to a secondary controller;
selecting at least one user media signal from a plurality of user media signals;
verifying the at least one user media signal or signals are functioning;
queuing the selected user media signal or signals;
receiving the at least one user media signal by the secondary controller;
editing the at least one user media signal by the secondary controller; and
integrating the edited user media signal or signals and the edited media source signal to create an integrated signal.

19. The method of producing interactive multimedia of claim 18, further comprising outputting the integrated signal.

20. The method of producing interactive multimedia of claim 19, wherein the integrated signal is output to a user producing the user media signal and to users producing the media source signal so that they may interact with each other.
